(19) United States
(12) Patent Application Publication
(10) Pub. No.: US 2003/0177040 A1
(43) Pub. Date: Sep. 18, 2003

(54) Method of managing personal medical data

(76) Inventors: Thomas Birkhoelzer, Radolfzell (DE); Frank Krickhahn, Herzogenaurach (DE)

Correspondence Address: HARNESS, DICKEY & PIERCE, P.L.C., P.O.BOX 8910, RESTON, VA, 20195, US

(21) Appl. No.: 10/359,202

(22) Filed: Feb. 6, 2003

(30) Foreign Application Priority Data
Feb. 6, 2002 (DE) 10204837.1

(51) Int. Cl. G06F 17/60

(52) U.S. Cl. 705/2

(57) ABSTRACT

References to personal medical data stored in individual computers are stored in a central computer, but not the personal medical data itself. The central computer receives from a user computer a request for personal medical data. It transmits to the user computer only the references to the corresponding personal medical data.

The present application hereby claims priority under 35 U.S.C. §119 on German patent application number DE 10204837.1 filed Feb. 6, 2002, the entire contents of which are hereby incorporated herein by reference.

### FIELD OF THE INVENTION

The present invention generally relates to a method of managing personal medical data.

In the course of the life-long treatment of a patient, data is produced in very many different information technology systems. The data is normally also stored and archived in these systems. However, it is normally only available locally there.

From the point of view of optimum treatment, it would be advantageous if the patient data (medical history) originating from earlier treatments and examinations could be made available to a treating doctor even if he is working outside the individual system.

One approach to a solution to this problem is to transmit all the data about a patient into a central patient folder, to which access can then be made from outside. However, this solution requires a central system since, for example, the central patient folder must be able to handle all the data. Thus, it must be able to, in particular, receive it, store it and interpret it to a certain extent. For limited fields of work, this succeeds to some extent, since the fundamental data formats are largely standardized. However, more developed integration always requires specific interface implementations, with which the respective information technology systems obtain access to the central patient folder.

A special case of a central patient folder is a so-called distributed patient folder, in which, although the data is stored in physically separate systems, the call continues to be made via an interface to the central patient folder. Although this approach has the advantage that each system only has to implement a single interface, namely that to the central patient folder, the complexity is displaced completely into the central system as a result. In particular, every change in a data format has to be taken into account in the central patient folder. In addition, the result is extremely complex tasks with respect to data integrity and access protection.

### SUMMARY OF THE INVENTION

An object of an embodiment of the present invention is to provide a method of managing personal medical data in which the above disadvantages are avoided.

The object may be achieved in that references to personal medical data stored in individual computers, but not the personal medical data itself, may be stored in a central computer. Further, the central computer receives from a user computer a request for personal medical data, and the central computer transmits to the user computer, references to the corresponding personal medical data.

Thus, the data then held in the central computer is only that which is relatively uncritical with regard to access protection and data integrity. Nevertheless, it is possible to find out from the user computer where the personal medical data is stored, so that this data can be traced from the user computer. The access to the personal medical data itself is carried out directly from the user computer to the respective individual computer, excluding the central computer. During the communication between the user computer and the individual computer, the required technologies for protecting the data and access protection are then of course taken into account.

If the references to the personal medical data are transmitted to the central computer via a point-to-point connection, they are specifically only transmitted to the central computer. The data integrity can therefore already be increased in the approach.

The references to the personal medical data can optionally be interrogated by the central computer in the individual computers or else transmitted to the central computer by the individual computers on their own initiative.

If the individual computers communicate with the central computer in accordance with the http protocol and/or transmit the references to the central computer in a format which is specified by an MIME type, recourse can be had to tried and tested standard communication methods.

If the central computer also receives an access authorization verification from the user computer before or together with the request for personal medical data, and transmits the references to the corresponding personal medical data to the user computer only when the access authorization verification is in order, protection against unauthorized accesses is already implemented at the time of access to the reference as such. The data protection to the personal medical data is further increased as a result.

If the user computer likewise communicates with the central computer via a point-to-point connection, the access protection to the references can be increased still further.

If the user computer communicates with the central computer in accordance with the http protocol and/or the central computer transmits the references to the user computer in a format which is specified by an MIME type, recourse can also be had to tried and tested standard methods for the communication between user computer and central computer.

### BRIEF DESCRIPTION OF THE DRAWINGS

Further advantages and details emerge from the following description of an exemplary embodiment in conjunction with the drawings, in which, in a basic illustration,

FIG. 1 shows a computer assembly; and

FIGS. 2-5 show flowcharts.

### DETAILED DESCRIPTION OF THE PREFERRED EMBODIMENTS

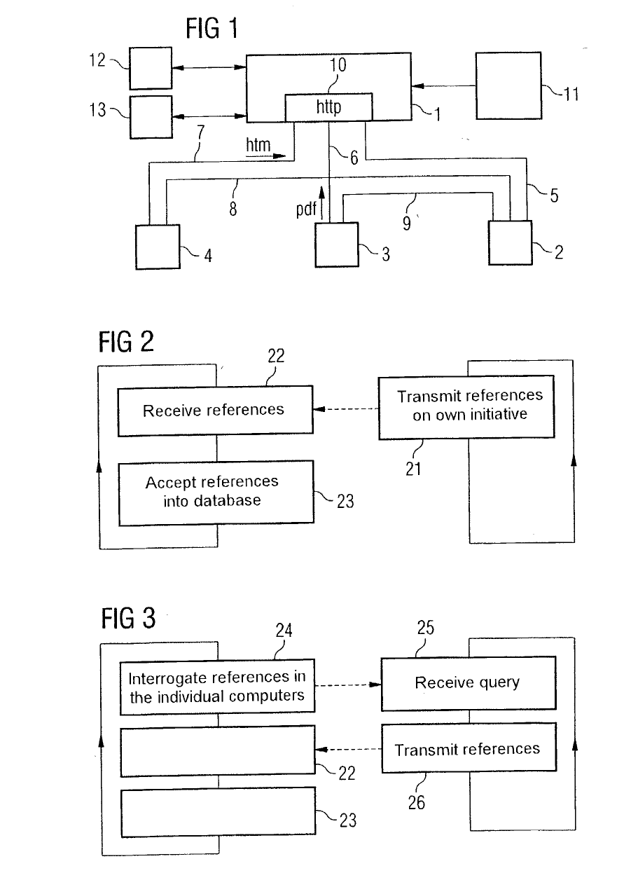

According to FIG. 1, a computer assembly has a central computer 1, a user computer 2 and individual computers 3, 4. The central computer 1 communicates with the user computer 2 and the individual computers 3, 4 via point-to-point connections 5 to 7. The user computer 2 can also communicate with the individual computers 3, 4, likewise via point-to-point connections. However, this is not significant within the context of an embodiment of the present invention.

The communication between the central computer 1 and the other computers 2 to 4 is carried out via an interface 10 which, according to FIG. 1, is designed as an http interface 10. The central computer 1 therefore communicates with the user computer 2 and the individual computers 3, 4 in accordance with the http protocol.

The central computer 1 executes a computer program product 11. Under the control of the computer program product 11, it makes access, inter alia, to a reference database 12 and an access authorization database 13.

In order to manage the reference database 12, references have to be stored in the reference database 12. This is preferably done as described below in conjunction with FIG. 2.

According to FIG. 2, in a step 21, the individual computers 3, 4 transmit references to personal medical data 14 to the central computer 1 on their own initiative. In this case, the transmission of the references to the central computer 1 is carried out, for example, in the html or in pdf format, as indicated in FIG. 1 by appropriate statements. However, it can also be carried out in another data format which is specified by an MIME type. The central computer 1 receives the references in a step 22 and accepts them into the reference database 12 in a step 23. It therefore stores them in the central computer 1.

In addition to the source information, the references may possibly additionally include in particular a patient identification, a code for the examination or treatment carried out and a data item and other data relevant to the classification of the reference. Furthermore, they include information as to the interfaces by which access can be made to the personal medical data 14. The personal medical data 14 itself, on the other hand, is not transmitted to the central computer 1. Instead, this is stored exclusively in the individual computers 3, 4.

As an alternative to the procedure described in FIG. 2, the procedure described below in conjunction with FIG. 3 is also possible.

According to FIG. 3, in a step 24 the central computer 1 interrogates the references in the individual computers 3, 4. These receive the request in a step 25 and, in a step 26, transmit the references to the central computer 1. In step 22, the central computer 1 then again receives the references and accepts them into the reference database 12 in step 23.

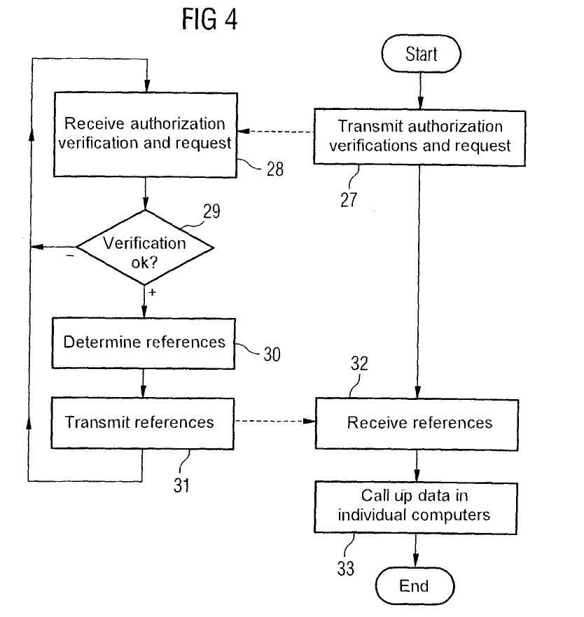

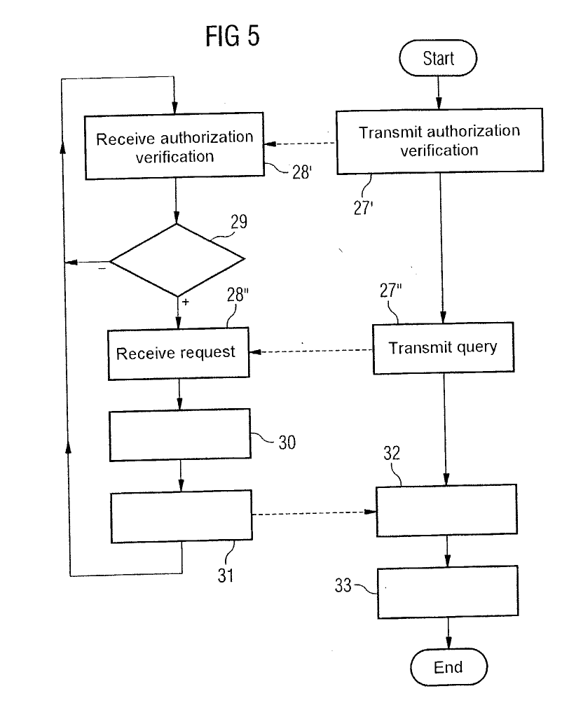

In the following text, with reference to FIG. 4, an interrogation of references by the user computer 2 will now be explained.

According to FIG. 2, in a step 27, the user computer 2 transmits an access authorization verification to the central computer 1 together with a request for personal medical data 14. The central computer 1 receives the request and the access authorization verification in a step 28. In a step 29, the central computer 1 then checks whether the access authorization verification transmitted is in order. This is carried out in particular by means of access to the access authorization database 13 and a comparison between the access authorization verification transmitted and the access authorizations stored there.

Only if the access authorization verification is in order will the following steps 30 to 33 be carried out.

In step 30, by using the reference database 12, the central computer 1 determines references to corresponding personal medical data 14. In step 31, it transmits the references determined to the user computer 2. In the process, the central computer 1 transmits the references to the user computer 2, for example, likewise in the html or in the pdf format, as indicated in FIG. 1. However, this can also be done in another data format which is specified by an MIME type. The user computer 2 receives the transmitted references in step 32. In step 33, the user computer 2 then calls up the personal medical data 14 from the individual computers 3, 4.

According to FIG. 4, the access authorization verification is transmitted to the central computer 1 by the user computer 2 together with the request. However, it is also possible, as illustrated in FIG. 5, to transmit the access authorization verification before the request. As a result, this is done by the step 27 from FIG. 4 being divided up into two part steps 27′, 27″. In part step 27′ only the authorization verification is transmitted, in part step 27″ only the request.

In an analogous way, the step 28 according to FIG. 4 is likewise divided up into two part steps 28′, 28″. In part step 28′, only the authorization verification is received, in part step 28″ only the request. Furthermore, as illustrated in FIG. 5, the step 29, in which the access authorization verification transmitted is checked, can be moved in front of the receipt of the request. However, this is not absolutely necessary.

In an embodiment of the present invention, therefore, the user computer 2 only interrogates the central computer 1 for a reference to the personal medical data 14. The data 14 itself is called up by the user computer 2 directly in the individual computers 3, 4. In the process, of course, a check—if appropriate a very comprehensive check—of the access authorization is again carried out, in order to ensure the requisite data protection.

By the method described, efficient management of the personal medical data 14 is therefore possible in a simple way.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of managing personal medical data, comprising:
storing references to personal medical data stored in individual computers, but not the personal medical data itself, the references being stored in a central computer;
receiving, at the central computer from a user computer, a request for personal medical data; and
transmitting, from the central computer to the user compute, references to the corresponding requested personal medical data.

2. The management method as claimed in claim 1, wherein the references to the personal medical data are transmitted to the central computer via a point-to-point connection.

3. The management method as claimed in claim 1, wherein the references to the personal medical data are interrogated by the central computer in the individual computers.

4. The management method as claimed in claim 1, wherein the references to the personal medical data are transmitted to the central computer by the individual computers on their own initiative.

5. The management method as claimed in claim 1, wherein the individual computers communicate with the central computer in accordance with the http protocol.

6. The management method as claimed in claim 1, wherein the individual computers transmit the references to the central computer in a format which is specified by an MIME type.

7. The management method as claimed in claim 1, wherein, before or together with the request for personal medical data, the central computer also receives an access authorization verification from the user computer, and wherein the central computer transmits the references to the corresponding personal medical data to the user computer only when the access authorization verification is in order.

8. The management method as claimed in claim 1, wherein the user computer communicates with the central computer via a point-to-point connection.

9. The management method as claimed in claim 1, wherein the user computer communicates with the central computer in accordance with the http protocol.

10. The management method as claimed in claim 1, wherein the central computer transmits the references to the user computer in a format which is specified by an MIME type.

11. A computer program product for implementing a management method as claimed in claim 1.

12. A central computer programmed with a computer program product as claimed in claim 11.

13. The management method as claimed in claim 2, wherein the references to the personal medical data are interrogated by the central computer in the individual computers.

14. The management method as claimed in claim 2, wherein the references to the personal medical data are transmitted to the central computer by the individual computers on their own initiative.

15. The management method as claimed in claim 2, wherein the individual computers communicate with the central computer in accordance with the http protocol.

16. The management method as claimed in claim 2, wherein the individual computers transmit the references to the central computer in a format which is specified by an MIME type.

17. The management method as claimed in claim 2, wherein, before or together with the request for personal medical data, the central computer also receives an access authorization verification from the user computer, and wherein the central computer transmits the references to the corresponding personal medical data to the user computer only when the access authorization verification is in order.

18. The management method as claimed in claim 2, wherein the user computer communicates with the central computer via a point-to-point connection.

19. The management method as claimed in claim 5, wherein the user computer communicates with the central computer in accordance with the http protocol.

20. The management method as claimed in claim 6, wherein the central computer transmits the references to the user computer in a format which is specified by an MIMIE type.

21. A computer program product for implementing a management method as claimed in claim 2.

22. A central computer programmed with a computer program product as claimed in claim 21.

23. A method of managing personal medical data, comprising:
storing references to personal medical data in a central computer, wherein the personal medical data is not stored in the central computer;
receiving at the central computer, a request for the personal medical data from a user computer; and
transmitting the references to the corresponding requested personal medical data from the central computer to the user computer.

24. A computer program product for implementing a management method as claimed in claim 23.

25. A central computer programmed with a computer program product as claimed in claim 24.

26. A system for managing personal medical data, comprising:
means for storing references to personal medical data in a central computer, wherein the personal medical data is not stored in the central computer;
means for receiving at the central computer, a request for the personal medical data from a user computer; and
means for transmitting the references to the corresponding requested personal medical data from the central computer to the user computer.
